(19) United States
(12) Patent Application Publication
(10) Pub. No.: US 2005/0057860 A1
(43) Pub. Date: Mar. 17, 2005

(54) Laser-welded actuator assembly

(76) Inventors: Joseph HengTung Lau, Singapore (SG); Terang KongBeng Thia, Singapore (SG); Xiong Liu, Singapore (SG)

Correspondence Address: Derek J. Berger;Seagate Technology LLC, Intellectual Property - COL2LGL, 389 Disc Drive, Longmont, CO, 80503, US

(21) Appl. No.: 10/664,107

(22) Filed: Sep. 17, 2003

(51) Int. Cl. G11B 5/55

(52) U.S. Cl. 360/265.7

(57) ABSTRACT

An actuator assembly that is formed by metallurgically bonding of the actuator arm and the voice coil support to the pivoting mechanism, such as by laser welding.

### FIELD OF THE INVENTION

The present invention relates generally to actuator assemblies for use in data storage devices. More particularly, the present invention relates to the manufacture of such assemblies.

### BACKGROUND OF THE INVENTION

Consumer demand for increasingly smaller and lighter portable electronic devices with improved and more reliable data storage capabilities is driving the push for miniaturization of data storage devices. In designing smaller and more robust data storage devices, engineers are faced with many challenges, one of which is the difficulty of assembling movable components. Conventional fasteners or assemblies may add to the thickness or width of the assembly, and thus be a hindrance to further overall size reduction of the data storage device.

Conventional fasteners may be inadequate in another aspect. For example, when the size of the actuator assembly is reduced beyond a certain point, there may be insufficient frictional forces or insufficient area for the fasteners to effect a secure attachment. Therefore, with the miniaturization of data storage devices, there is a need to explore alternative methods of assembly.

At the same time, any alternative method of assembly should preferably be amenable to automation so that the final product, be it a data storage device or other consumer electronic device, can be made available to the public at affordable prices. Innovative solutions to such problems are required.

In addition to providing a solution that overcomes these and other problems, the present invention also offers further advantages over conventional assemblies.

### SUMMARY OF THE INVENTION

The present invention relates to the assembly of actuator assemblies for use in data storage devices such as disc drives.

In accordance with embodiments of the invention, rotatable portions of an actuator assembly are metallurgically bonded together, for example by using lasers to form at least one spot-weld. The rotatable portions may include an actuator arm, a voice coil support, and the rotatable part of a pivot mechanism. Embodiments of the present invention may further provide for contact between the actuator beam and the rotatable part of the pivot mechanism. Preferably, contact is provided between at least a part of the actuator beam and at least one transverse extension from the rotatable part of the pivot mechanism.

Some embodiments involve welding an actuator beam to a rotatable part of the pivot mechanism, where the actuator beam is a monolithic structure having the actuator arm and the voice coil support. During assembly, components of the actuator assembly are preferably introduced to the place of assembly from generally the same direction as the laser.

These and various other features as well as advantages which characterize the present invention will be apparent upon reading of the following detailed description and review of the associated drawings.

### BRIEF DESCRIPTION OF THE DRAWINGS

FIG. 1 is a top view of a disc drive.

FIG. 2 is an exploded view showing an actuator assembly of one embodiment of the present invention.

FIG. 3 is a schematic cross-sectional view of the actuator assembly of FIG. 2.

FIG. 4 is a perspective view according to another embodiment of the present invention.

FIG. 5 shows another embodiment of the present invention.

### DETAILED DESCRIPTION

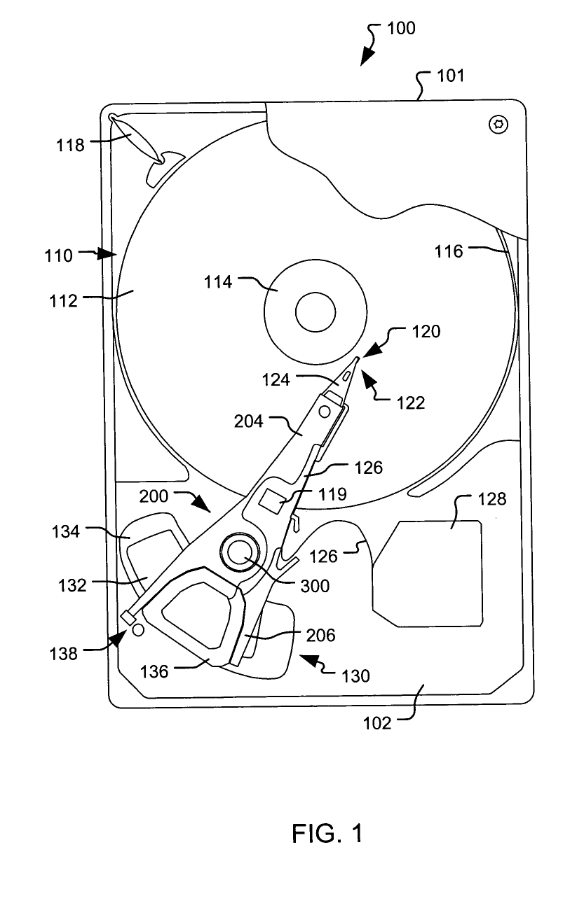

FIG. 1 shows a top view of a disc drive 100, with part of its housing 101 removed to reveal the components mounted within. The housing 101 may include a base deck 102. Not shown is a printed circuit board assembly that is attached to the other side of the base deck 102.

Rotatably mounted to the base deck 102 is a disc stack assembly 110 made up of a disc 112 that is secured to a spindle motor by a disc clamp 114. The disc stack assembly 110 may be located in a cavity formed by the base deck 102 so that the disc stack assembly is at least partially surrounded by a shroud 116 extending transversely alongside the edge of the disc 112. When the disc stack assembly 110 rotates, air or fluid near the disc stack assembly is dragged into motion along with the rotating disc 112. A filter 118 may be positioned adjacent the disc stack assembly 110 to trap contaminants in the moving air or fluid, thereby helping to maintain a clean environment within the housing 101.

At least one of the major surfaces of the disc 112 is formatted for storing data. Data is written to and read from one or more tracks on a disc surface by read/write heads 120. The read/write heads 120 may be part of a head gimbal assembly 122 that is suspended from one end of a suspension 124, which is in turn attached to a pivotably mounted actuator arm 204. In addition to other functions, the actuator arm 204 serves as a framework for supporting wiring 126 (which may be in the form of a printed circuit cable) that runs from the head gimbal assembly 122 to a connector or bracket 128, from where it communicates with the printed circuit board assembly. A pre-amplifier 119 or other integrated-circuit chips may be located on the actuator assembly 126 to provide improved signal transmission.

In the present context, an actuator assembly 200 refers to an assembly that includes an actuator arm 204, a rotator 310, and a movable part 206 of a voice coil motor 130 that sets the actuator arm 204 in motion. The rotator 310 is a rotatable part of a pivot mechanism 310 for enabling rotational movement of the actuator arm 204. The movable part 206 of the voice coil motor 130 may be a voice coil support 206 to which a voice coil 136 is attached. The voice coil motor 130 further includes a permanent magnet 132 and a configuration of one or more poles 134 designed to close the magnetic flux from the magnet 132. By controlling the current to the voice coil 136 of the voice coil motor 130, the actuator arm 204 can be used to position the read/write heads 120 at a desired track when data is being read from or written to the track, or to move the read/write heads 120 to a new track location.

The actuator assembly 200 may be limited in its range of movement by suitable placement of limit stops or latches 138.

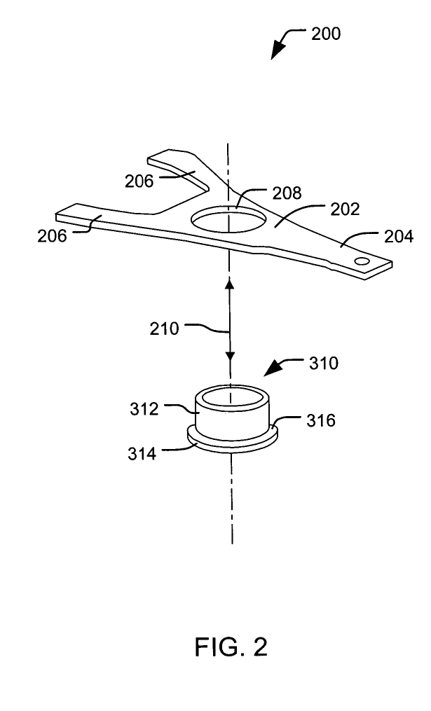

Turning to FIG. 2 for a further description of the actuator assembly 200, the actuator arm 204 and the voice coil support 206 are shown as being part of a monolithic actuator beam 202. The actuator beam 202 may define an aperture 208 that is shaped for receiving the Divot mechanism 300.

One part of the actuator beam 202 that extends away from the aperture 208 serves as an actuator arm 204. The distal end of the actuator arm 204 provides for attachment to a suspension 124 that can support a head gimbal assembly 122 (FIG. 1). Another part of the actuator beam 202 extends away from the aperture 208 to serve as a voice coil support 206. The voice coil support 206 may be in the form of two spaced-apart extensions suitably sized to receive the voice coil 136 between the extensions. The distal ends of the extensions 206 may be configured to form part of a limit stop or a latch 138 (FIG. 1) so as to provide some limitation to the range of movement of the actuator assembly 200 or to immobilize the actuator assembly 200 when the disc drive 100 is not in operation. The actuator arm 204 and the voice coil support 206 may extend away from the aperture 208 in generally opposite directions.

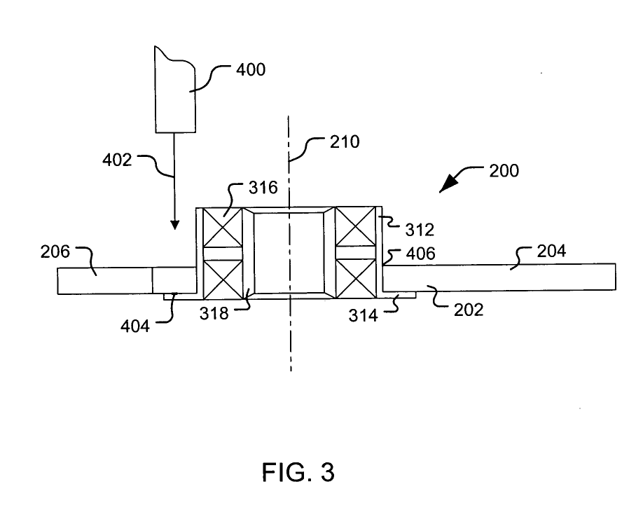

The pivot mechanism 300 can be one in which the rotator 310 is in engagement with a stationary portion 318 via a set of bearings 316 (FIG. 3). The stationary portion 318 may be in the form of a shaft that is mountable to the base deck 102 to provide for rotational movement of the rotator 310 (and accordingly, the actuator arm 204) relative to the base deck 102 about an axis of rotation 210. The axis of rotation 210 is taken to define an axial direction. It will also be understood that the pivot mechanism 300 may not be one that operates on bearings since other forms of pivot mechanisms can provide the same functionality of enabling rotational movement of the actuator assembly 200.

The rotator 310 of the pivot mechanism 300 includes a sleeve 312. The sleeve 312 is generally oriented along the axial direction 210. The sleeve 312 may be in the form of a hollow cylinder coupled on the inside to the bearings 316. A flange 314 extends radially outward from one edge of the sleeve 312, to provide at least one abutment surface 316 that is transverse to the axial direction 210. The abutment surface 316 is configured for abutment with at least part of the actuator beam 202. The abutment surface 316 may extend continuously along the circumference of the sleeve 312. Alternatively, the flange 314 may not be continuous throughout the circumference of the sleeve 312.

During the assembly process, the rotator 310 of the pivot mechanism 300 is assembled to the actuator beam 202 by fitting the sleeve 312 through the aperture 208 until the actuator beam 202 abuts the abutment surface 316 of the flange 314. As illustrated in FIG. 2, this step involves relative movement of the sleeve 312 and the actuator beam 202 along the axial direction 210. Next, the actuator beam 202 and the rotator 310 are laser welded together. In particular, spot welds 404, 406 can be formed at the interface between the rotator 310 and the actuator beam 202. Thus, the laser welds may be formed between the flange 314 and the actuator beam 202, or the welds 406 may be formed between the sleeve 312 and the actuator beam 202. In both cases, the actuator assembly 200 is held together by direct metallurgical bonds between the actuator arm 204 and the pivot mechanism 300, as illustrated in FIG. 3.

FIG. 3 further shows an example where a laser welding apparatus 400 is configured to direct a laser 402 in a direction substantially parallel to the axial direction 210. Such a configuration is designed for manufacturability because the pre-assembled components and the laser can be introduced to the assembly from the same direction. Accordingly, fewer points of access need to be provided on the assembly line, thus facilitating automation for volume manufacture. This is another advantage over conventional assemblies where more access points would have been required to attach or tighten fasteners.

It is contemplated that the laser 400 may alternatively be directed from a direction that is at an angle to the axial direction 210, or it can be directed from a direction opposite to that shown in FIG. 3. Different embodiments of the present invention can therefore be deployed according to the physical constraints of the manufacturing environment without going beyond the scope of the invention.

It can be seen from the description above that, not only does the resultant actuator assembly 200 require fewer steps to assemble, fewer components will actually be required. Manufacture of the actuator assembly 200 is also simpler than conventional processes because no additional clamping or fastening processes are required. Overall, this can lead to improved manufacturing efficiencies and lower costs.

Furthermore, embodiments of the present invention are particularly suited for making miniature actuator assemblies where the amount of friction between very small interface areas may be insufficient for effecting a secure joint using other methods.

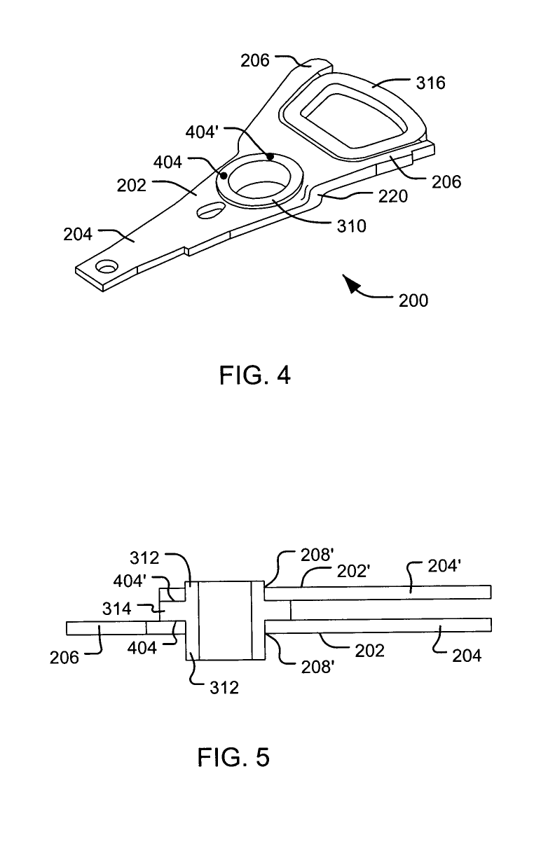

FIG. 4 shows an alternative embodiment where the actuator beam 202 is not configured to have the same elevation throughout its length. In this example, a step 220 is provided between the actuator arm 204 and the voice coil support 206 of the actuator beam 202. In assembly, the voice coil support 206 and the actuator arm 204 may be at different elevations to optimize space utilization within the housing 101.

It is proposed that two spaced-apart laser welds 404, 404′ are formed, although the number of laser welds may be varied. By varying the size of the welds and the number of welds, the integrity of the assembly can be controlled. Material choice for the actuator beam 202 and the rotator 310 is not constrained by the method of assembly because laser welding can be used to effectively join together both similar and dissimilar materials.

FIG. 5 shows an alternative embodiment where more than one actuator beam is attached to the rotator 310. The flange 314 is spaced away from both ends of the sleeve 312 and provides for abutment on both of its major surfaces with actuator beams 202, 202′. Laser welds 404, 404′ can be formed where there is abutment between the rotatable part 310 and the actuator beams 202, 202′. One of the actuator beams 202′ may include only an aperture 208′ for engagement with the sleeve 312 and an actuator arm 204′ for supporting the head gimbal assembly. Another actuator beam 202 may include an aperture 208 for engagement with the sleeve 312, an actuator arm 204 for supporting the head gimbal assembly, and a voice coil support 206 that forms part of the voice coil motor. In such embodiments, direct welding of the actuator beams 202, 202′ to the rotator 310 again provide advantages over conventional assemblies, for example, improved manufacturability and decreased space requirement.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed.

1. An actuator assembly comprising:
a pivot assembly comprising:
a first portion configured to be fixed with respect to a base; and
a second portion movable with respect to the first portion; and
an actuator mounted to the second portion by a metallurgical bond.

2. The actuator assembly of claim 1 in which the second portion further comprises:
a sleeve; and
a flange extending transversely from the sleeve.

3. The actuator assembly of claim 2 in which the actuator touches the flange.

4. The actuator assembly of claim 3 in which the actuator is metallurgically bonded to the flange.

5. The actuator assembly of claim 3 in which the actuator is metallurgically bonded to the sleeve.

6. The actuator assembly of claim 1 in which the actuator further defines an aperture sized to receive the second portion.

7. The actuator assembly of claim 1 in which the metallurgical bond is produced by laser welding.

8. The actuator assembly of claim 1 in which the actuator further comprises an actuator arm and a voice coil support extending in generally opposite directions away from the second portion.

9. A data storage device comprising:
a base;
a storage medium; and
the actuator assembly of claim 1, in which the actuator is configured to access the storage medium and the rotator is mounted to the base.

10. The data storage device of claim 9, in which the storage medium comprises a rotatable disc.

11. The data storage device of claim 9, in which the storage medium comprises a magnetic medium.

12. A method of making an actuator assembly comprising steps of:
(a) bringing an actuator beam into abutment with a rotating portion of a pivot mechanism; and
(b) laser welding the actuator beam to the rotating portion.

13. The method of claim 12 in which the bringing step (a) further comprises passing a sleeve of the rotating portion through an aperture in the actuator beam.

14. The method of claim 13 in which the bringing step (a) further comprises bringing at least one portion of the actuator beam into abutment with a flange extending from the sleeve.

15. The method of claim 14 in which the bringing step (a) involves providing from a first direction one of the actuator beam and the sleeve;
and in which the welding step (b) involves directing a laser from the first direction.

16. The method of claim 15 in which the welding step (b) further comprises forming at least one spot-weld joining the actuator beam and the rotator.

17. An actuator assembly comprising:
a pivot mechanism;
an actuator arm; and
means for bonding the actuator arm directly to the rotator.
